(19) United States
(12) Patent Application Publication
(10) Pub. No.: US 2024/0324766 A1
(43) Pub. Date: Oct. 3, 2024

(54) DRESSING TABLE

(71) Applicant: ZHIGANG ZHANG, TIANJIN (CN)

(72) Inventor: ZHIGANG ZHANG, TIANJIN (CN)

(21) Appl. No.: 18/127,127

(22) Filed: Mar. 28, 2023

(51) Int. Cl. A47B 67/00

(52) U.S. Cl. CPC A47B 67/005; A47B 2220/0077; F21V 23/003; G06F 3/167; H02J 50/10

(57) ABSTRACT

A dressing table includes a mirror table, a dressing mirror, a light-emitting lamp, a voice collector, and a controller. The dressing mirror is disposed on the mirror table. The light-emitting lamp is disposed on the dressing mirror. The voice collector collects voice information. The controller is electrically connected to the voice collector and the light-emitting lamp. The controller controls the light-emitting lamp according to the voice information.

### TECHNICAL FIELD

The present disclosure relates to a technical field of smart home, and in particular to a dressing table.

### BACKGROUND

Dressing tables are common furniture frequently used in daily life of people, and the dressing tables each is generally combined with a table and a dressing mirror. A table top of the table is capable of placing articles, such as cosmetic products. The dressing mirror is capable of tidying appearance for the people, for example, capable of assisting users in making up, dressing hair, finishing headwear, and so on. When using the dressing table, people often face away from a main light source in a bedroom, so that the dressing mirror cannot achieve a good effect. In a related technology, a light-emitting lamp is additionally disposed on the dressing mirror to improve brightness of the dressing mirror, which is convenient for users to use the dressing mirror. However, the light-emitting lamp is inconvenient to control.

### SUMMARY

The present disclosure provides a dressing table, and the dressing table controls a light-emitting lamp matched with a dressing mirror through voice, which is convenient to control.

The present disclosure provides the dressing table, including: a mirror table, a dressing mirror, a light-emitting lamp, a voice collector, and a controller. The dressing mirror is disposed on the mirror table. The light-emitting lamp is disposed on the dressing mirror. The voice collector collects voice information. The controller is electrically connected to the voice collector and the light-emitting lamp. The controller controls the light-emitting lamp according to the voice information.

Optionally, the voice collector and the controller are disposed on the dressing mirror.

Optionally, the dressing mirror includes a mounting bracket and a mirror. The mirror is disposed on the mounting bracket. The mounting bracket is disposed on the mirror table. An accommodating space is formed in the mounting bracket.

The dressing table further includes a circuit board. The voice collector and the controller are disposed on the circuit board. The circuit board is disposed in the accommodating space.

Optionally, an opening is formed in an edge of the mounting bracket. The opening is communicated with the accommodating space.

The circuit board includes a first interface. The first interface is disposed in the opening.

The mirror table includes a second interface for supplying power. The second interface is plugged into the first interface to realize electrical connection and supply power to the circuit board.

Optionally, the circuit board further includes a wireless receiving circuit.

The mirror table includes a wireless transmitting circuit. The wireless transmitting circuit is matched with the wireless receiving circuit for supplying power to the circuit board.

Optionally, the dressing table further includes a battery. The battery is disposed in the accommodating space. The battery is electrically connected to the circuit board for supplying power to the circuit board.

Optionally, the light-emitting lamp includes a plurality of light-emitting units. The plurality of the light-emitting units are disposed around the mirror by a circle.

Optionally, the dressing table further includes a control key. The control key is disposed on the dressing mirror. The control key is electrically connected to the light-emitting lamp for controlling the light-emitting lamp.

Optionally, the voice collector and the controller are disposed on the mirror table.

Optionally, the dressing table further includes a circuit board. The voice collector and the controller are disposed on the circuit board. The circuit board is disposed on the mirror table. The circuit board includes a third interface. The light-emitting lamp includes a fourth interface. The third interface is electrically connected to the fourth interface for enabling the circuit board to supply power to the light-emitting lamp.

Optionally, the voice collector is disposed on the dressing mirror. The controller is disposed on the mirror table. The voice collector and the light-emitting lamp are both electrically connected to the controller.

Optionally, the controller is disposed on the dressing mirror. The voice collector is disposed on the mirror table. The voice collector and the light-emitting lamp are both electrically connected to the controller.

Optionally, the controller is disposed on a back surface of the dressing mirror.

Optionally, the dressing table further includes a voice player. The voice player is connected to the controller. The voice player plays audio signals sent by the controller.

Optionally, the controller is in voice interaction with a user through the voice collector and the voice player.

Optionally, the voice player and the voice collector are disposed at intervals on the dressing mirror.

Optionally, the voice player and the voice collector are disposed at intervals on the mirror table.

Optionally, one of the voice player and the voice collector is disposed on the dressing mirror. The other one of the voice player and the voice collector is disposed on the mirror table.

Optionally, the dressing table includes a bearing plate, two mounting frames, and a plurality of supporting legs. The plurality of the supporting legs and the two mounting frames are disposed on two opposite sides of the bearing plate. The plurality of the supporting legs are connected to the bearing plate for supporting the bearing plate. The two mounting frames are disposed at intervals. A mounting groove is defined on each of the two mounting frames. The dressing mirror is clamped in the two mounting grooves.

Optionally, the mirror table further includes two dressing boxes. The two dressing boxes and the two mounting frames are disposed on a same side of the bearing plate. The two dressing boxes are disposed on two sides of the dressing mirror.

### BRIEF DESCRIPTION OF DRAWINGS

In order to more clearly illustrate technical solutions in embodiments of the present disclosure, drawings that need to be used in description of the embodiments are briefly described below. In an obvious way, the drawings in the following description are merely some embodiments of the present disclosure, and for a person skilled in art, other drawings are obtained according to the drawings without involving any inventive effort.

For a more complete understanding of the present disclosure and beneficial effects of the present disclosure, the following description is made in conjunction with the accompanying drawings, in which same reference numerals refer to same portions in the following description.

FIG. 1 is a first structural schematic diagram of a dressing table according to one embodiment of the present disclosure.

FIG. 2 is a schematic diagram of a connection of a light-emitting lamp, a voice collector, and a controller in the dressing table shown in FIG. 1.

FIG. 3 is a structural schematic diagram of the dressing table shown in FIG. 1 at a first angle.

FIG. 4 is a structural schematic diagram of a circuit board according to one embodiment of the present disclosure.

FIG. 5 is a first simplified schematic diagram of the dressing table shown in FIG. 3.

FIG. 6 is a second simplified schematic diagram of the dressing table shown in FIG. 3.

FIG. 7 is a third simplified schematic diagram of the dressing table shown in FIG. 3.

FIG. 8 is a second structural schematic diagram of the dressing table shown in FIG. 1 at a second angle.

FIG. 9 is a simplified schematic diagram of the dressing table shown in FIG. 8.

FIG. 10 is a third structural schematic diagram of the dressing table shown in FIG. 1 at a third angle.

FIG. 11 is a fourth structural schematic diagram of the dressing table shown in FIG. 1 at a fourth angle.

FIG. 12 is a fifth structural schematic diagram of the dressing table shown in FIG. 1 at a fifth angle.

FIG. 13 is a structural schematic diagram of a mirror table in the dressing table shown in FIG. 1.

FIG. 14 is a partial structural schematic diagram of the mirror table shown in FIG. 13.

Reference number in the drawings:

1. dressing table; 12. mirror table; 122. second interface; 123. wireless transmitting circuit; 124. bearing plate; 126. mounting frames; 1262. mounting grooves; 128. supporting legs; 129. dressing boxes; 14. dressing mirror; 142. mounting bracket; 1421. accommodating space; 1423. opening; 144. mirror; 161. circuit board; 1612. first interface; 1614. control key; 1616. third interface; 162. light-emitting lamp; 1622. light-emitting units; 1624. fourth interface; 163. wireless receiving circuit; 164. voice collector; 165. battery; 166. controller; 168. voice player.

### DETAILED DESCRIPTION

By combining drawings in embodiments of the present disclosure, technical solutions in the embodiments of the present disclosure are clearly and completely described as follows. Obviously, the described embodiments are only a part of the embodiments of the present disclosure, rather than all the embodiments. On a basis of the embodiments of the present disclosure, all other embodiments obtained by a person skilled in art without involving any inventive effort belong to a protection scope of the present disclosure.

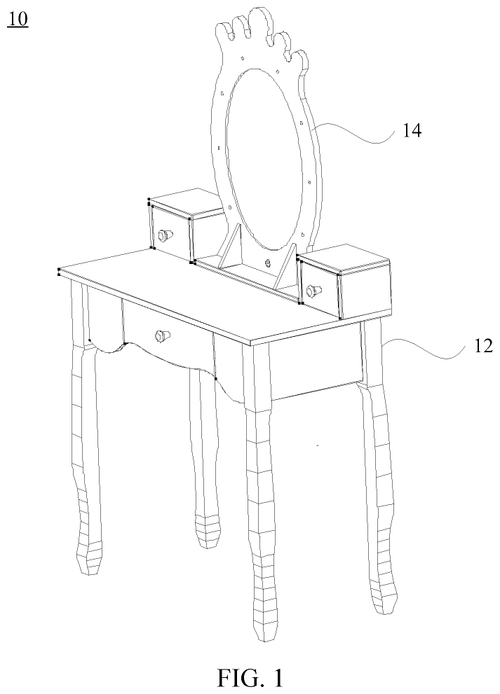

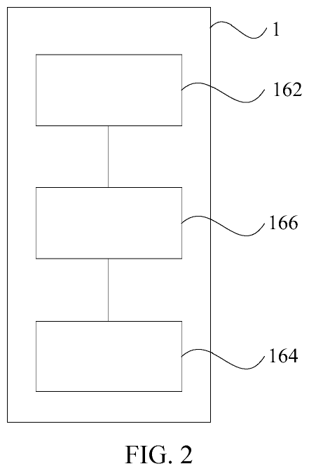

The present disclosure provides a dressing table. Referring to FIGS. 1-2, FIG. 1 is a first structural schematic diagram of a dressing table according to one embodiment of the present disclosure. FIG. 2 is a schematic diagram of a connection of a light-emitting lamp, a voice collector, and a controller in the dressing table shown in FIG. 1. The dressing table 1 includes: a mirror table 12, a dressing mirror 14, a light-emitting lamp 162, a voice collector 164, and a controller 166.

An upper surface of the mirror table 12 is configured as a placement surface, which is configured to place articles such as cosmetic products. The mirror table 12 is a table or another table-like device.

The dressing mirror 14 is disposed on the mirror table 12. The dressing mirror 14 is configured to arrange ceremony, for example, to assist a user in making up, arranging hair, finishing headwear, and so on.

The light-emitting lamp 162 is disposed on the dressing mirror 14. Due to a fact that the dressing table 1 is facing away from a main indoor light source, the light-emitting lamp 162 provides auxiliary light to avoid dim and unclear colors when illuminating the dressing mirror 14.

The voice collector 164 collects voice information. The voice collector 164 is equipment such as a microphone and is configured to collect voice information of the user.

The controller 166 is electrically connected to the voice collector 164 and the light-emitting lamp 162. The controller 166 controls the light-emitting lamp 162 according to the voice information.

The voice collector 164 collects the voice information of the user, and then the controller 166 controls the light-emitting lamp 162 according to the voice information. For example, the light-emitting lamp 162 is controlled to be turned on or turned off, which is convenient for the user for controlling the light-emitting lamp 162. For example, when two hands of the user occupy for makeup, the user operates the light-emitting lamp 162 through voice without putting down anything. The user controls the light-emitting lamp 162 without touching the dressing table 1, that is, the user controls the light-emitting lamp 162 by a distance from the dressing table 1. For example, after the user leaves the dressing table 1 for a certain distance, the light-emitting lamp 162 does not need to be turned off, and the light-emitting lamp 162 is controlled to be closed through voice. Light-emitting brightness of the light-emitting lamp 162 is controlled through voice, for example, the light-emitting brightness of the light-emitting lamp 162 is increased, or the light-emitting brightness of the light-emitting lamp 162 is reduced, and so on.

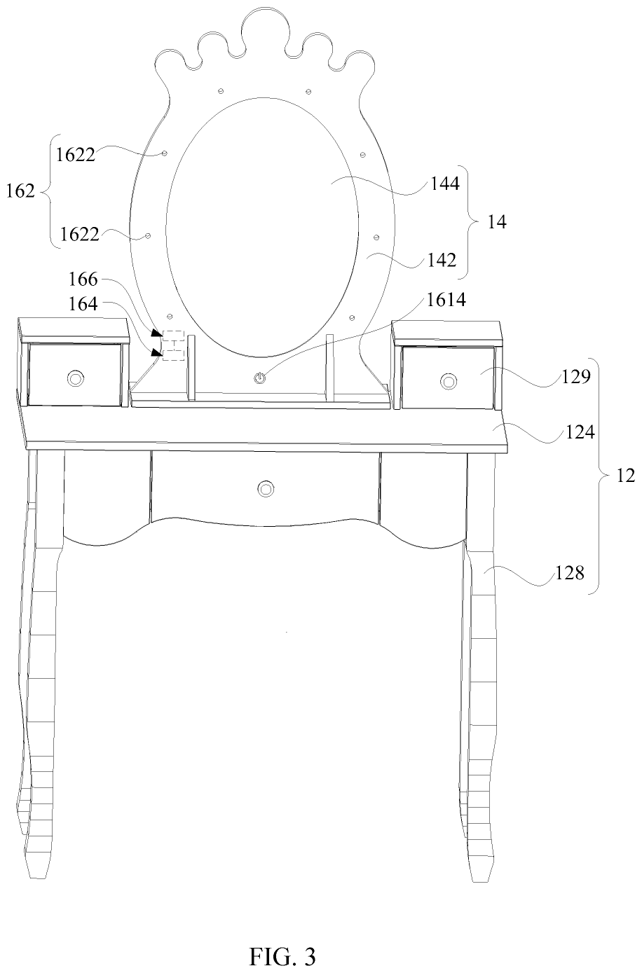

Referring to FIG. 3, FIG. 3 is a structural schematic diagram of the dressing table shown in FIG. 1 at another angle. In some optional embodiments, the voice collector 164 and the controller 166 are disposed on the dressing mirror 14. That is, the light-emitting lamp 162, the voice collector 164, and the controller 166 are disposed on the dressing mirror 14. The light-emitting lamp 162, the voice collector 164, and the controller 166 form a circuit device group of the dressing table 1. The dressing mirror 14 having the circuit device group independently completes voice control of the light-emitting lamp 162. The dressing mirror 14 having the circuit device group is adapted to a plurality of types of the mirror tables 12 to form a plurality of dressing tables 1 of various specifications to match different users.

It is noted that a shape of the dressing mirror 14 is set according to requirements. The dressing mirrors 14 in different shapes are disposed with the circuit device groups, and in combination with different types of the mirror tables 12, so that a plurality of the dressing tables 1 are combined to meet the requirements of the different users.

The controller 166 adjusts the light-emitting brightness of the light-emitting lamp 162 through adjusting voltage value or current value provided to the light-emitting lamp 162. The controller 166 further adjusts duty cycle of the Pulse Width Modulation (PWM) signal provided to the light-emitting lamp 162 to adjust the light-emitting brightness of the light-emitting lamp 162.

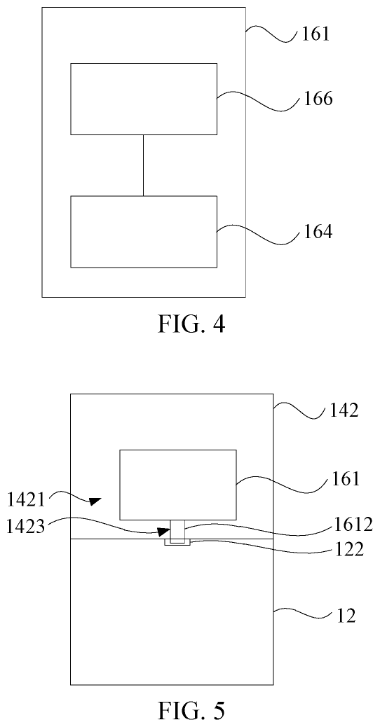

Referring to FIGS. 4-5, FIG. 4 is a structural schematic diagram of a circuit board according to one embodiment of the present disclosure. FIG. 5 is a first simplified schematic diagram of the dressing table shown in FIG. 3. In some embodiments, the dressing mirror 14 includes a mounting bracket 142 and a mirror 144. The mirror 144 is disposed on the mounting bracket 142. The mounting bracket 142 is disposed on the mirror table 12. An accommodating space 1421 is formed in the mounting bracket 142. The dressing table 1 further includes a circuit board 161. The voice collector 164 and the controller 166 are disposed on the circuit board 161. The circuit board 161 is disposed in the accommodating space 1421. The mounting bracket 142 is configured to dispose the mirror 144 and protect the mirror 144 at the same time. The mounting bracket 142 further accommodates the circuit board 161 where the voice collector 164 and the controller 166 are located, and protects the circuit board 161.

The light-emitting lamp 162 is further disposed in the mounting bracket 142, and the light-emitting lamp 162 and the circuit board 161 are both disposed in the mounting bracket 142, thereby facilitating electrical connection between the light-emitting lamp 162 and the circuit board 161. For example, the light-emitting lamp 162 is further disposed in an accommodating cavity of the mounting bracket 142, and the light-emitting lamp 162 is electrically connected to the circuit board 161, thereby realizing electrical connection between the light-emitting lamp 162 and the controller 166.

In some embodiments, an opening 1423 is formed in an edge of the mounting bracket 142. The opening 1423 is communicated with the accommodating space 1421. The circuit board 161 includes a first interface 1612. The first interface 1612 is disposed in the opening 1423. The mirror table 12 includes a second interface 122 for supplying power. The second interface 122 is plugged into the first interface 1612 to realize electrical connection and supply power to the circuit board 161.

The second interface 122 of the mirror table 12 is electrically connected to the first interface 1612 of the circuit board 161. The circuit board 161 supplies power through the electrically connected first interface 1612 and the electrically connected second interface 122. The first interface 1612 and the second interface 122 are disposed according to the requirements, such as a USB interface, a Micro-USB interface, or a Type-C interface, etc. The dressing mirror 14 is electrically connected to the mirror table 12 through the first interface 1612. The dressing mirror 14 is conveniently and electrically connected to the mirror table 12. The same dressing mirror 14 is adapted to different mirror tables 12, and similarly, the same mirror table 12 is adapted to different dressing mirrors 14.

Referring to FIG. 6, FIG. 6 is a second simplified schematic diagram of the dressing table shown in FIG. 3. In some embodiments, the circuit board 161 further includes a wireless receiving circuit 163. The mirror table 12 includes a wireless transmitting circuit 123. The wireless transmitting circuit 123 is matched with the wireless receiving circuit 163 for supplying power to the circuit board 161. The wireless transmitting circuit 123 of the mirror table 12 and the wireless receiving circuit 163 of the dressing mirror 14 realize wireless power supply. There is no need to set exposed interfaces on the dressing mirror 14 and the mirror table 12. The dressing mirror 14 does not include the opening 1423, making it difficult for water and dust to enter, so that the dressing mirror 14 is good in waterproof and dustproof effect and is attractive in appearance.

The wireless receiving circuit 163 is disposed opposite to the wireless transmitting circuit 123. For example, the wireless receiving circuit 163 includes a wireless receiving coil. The wireless transmitting circuit 123 includes a wireless transmitting coil. The wireless transmitting coil and the wireless receiving coil are oppositely disposed, and a distance between the wireless transmitting coil and the wireless receiving coil is small, so that energy transmission efficiency between the wireless transmitting coil and the wireless receiving coil is high, which meets power supply requirement of the circuit board 161, and meanwhile reduces energy waste as much as possible.

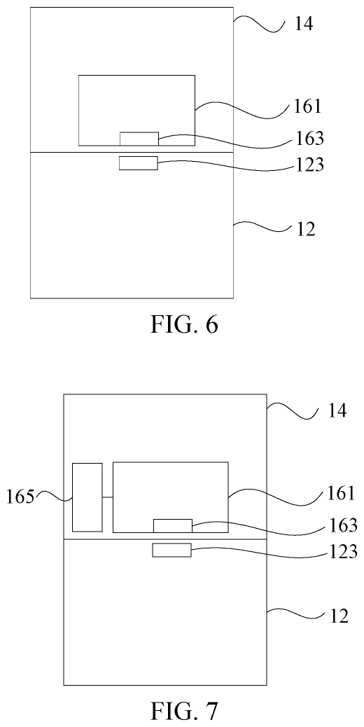

Referring to FIG. 7, FIG. 7 is a third simplified schematic diagram of the dressing table shown in FIG. 3. In some embodiments, the dressing table 1 further includes a battery 165. The battery 165 is disposed in the accommodating space 1421. The battery 165 is electrically connected to the circuit board 161 for supplying power to the circuit board 161.

An electric device in the dressing mirror 14, such as the light-emitting lamp 162 and the circuit board 161 having the voice collector 164 and the controller 166, is directly powered through the mirror table 12, and is further powered through the battery 165. For example, when the mirror table 12 supplies power, such as supplying power through the first interface 1612 of the circuit board 161 and the second interface 122 of the mirror table 12, or supplying power through the wireless transmitting circuit 123 of the mirror table 12 and the wireless receiving circuit 163 of the circuit board 161, the circuit board 161 is directly supplied with power through the mirror table 12, or the mirror table 12 further charges the battery 165 first, and then the battery 165 supplies power to the circuit board 161. When the mirror table 12 does not supply power, the circuit board 161 is powered through the battery 165.

In some embodiments, the battery 165 is a non-rechargeable battery or a rechargeable battery. The battery 165 is detachably disposed in the dressing mirror 14. For example, the mounting bracket 142 includes a detachable rear cover. After the rear cover is detached, the battery 165 in the dressing mirror 14 is detached and replaced with a new battery 165, and after the new battery 165 is replaced, the rear cover is disposed to protect the new battery 165 in the dressing mirror 14.

In some other embodiments, the battery 165 is further fixedly disposed within the dressing mirror 14. The battery 165 is a rechargeable battery, and the battery 165 is charged through the mirror table 12 or other ways. For example, the battery 165 is charged through the first interface 1612 of the circuit board 161 and the second interface 122 of the mirror table 12, or the battery 165 is charged through the wireless transmitting circuit 123 of the mirror table 12 and the wireless receiving circuit 163 of the circuit board 161.

It is noted that when the wireless transmitting circuit 123 of the mirror table 12 and the wireless receiving circuit 163 of the circuit board 161 are wirelessly powered, transmitted electric energy is unstable. Supplying power to the circuit board 161 through the battery 165 provides stable electrical energy and reduces damage caused by unstable electrical energy to the circuit board 161.

Please continue to refer to FIG. 3, in some embodiments, the light-emitting lamp 162 includes a plurality of light-emitting units 1622. The plurality of the light-emitting units 1622 are disposed around the mirror 144 by a circle. The plurality of the light-emitting units 1622 around the mirror 144 provide sufficient light, and provide light from a plurality of angles to prevent the provided light from not uniformly affecting the effect.

The plurality of the light-emitting units 1622 are a plurality of LED lamps. In some other embodiments, the light-emitting lamp 162 is one or more light bars.

It is understood that the light-emitting lamp 162 further includes an optical structure for uniformly diffusing light emitted by the plurality of the light-emitting units 1622. For example, the light-emitting lamp 162 further includes an optical cover covering the plurality of the light-emitting units 1622, and the optical cover uniformly mixes the light emitted by the plurality of the light-emitting units 1622, thereby providing more uniform light. A light-emitting side of the plurality of the light-emitting units 1622 are further disposed with at least one light film of a diffusion film, a diffuse reflection film, and the like.

In some embodiments, the dressing table 1 further includes a control key 1614. The control key 1614 is disposed on the dressing mirror 14, such as on the mounting bracket 142 of the dressing mirror 14. The control key 1614 is electrically connected to the light-emitting lamp 162 for controlling the light-emitting lamp 162.

The control key 1614 is at least one of a push-type key, a touch-type key, and a rotary-type key. The control key 1614 controls opening or closing of the light-emitting lamp 162, and further controls brightness adjustment of the light-emitting lamp 162. For example, if the touch-type key detects an operation in a first direction such as a right direction, the touch-type key increases the light-emitting brightness of the light-emitting lamp 162. For another example, if the touch-type key detects an operation in a second direction such as a left direction, the touch-type key reduces the light-emitting brightness of the light-emitting lamp 162. For another example, if the touch-type key detects a rotation operation in a first direction such as a clockwise direction, the touch-type key increases the light-emitting brightness of the light-emitting lamp 162. For another example, if the touch-type key detects a rotation operation in a second direction such as a counter-clockwise direction, the touch-type key reduces the light-emitting brightness of the light-emitting lamp 162.

The number and types of the control keys 1614 are set as required. For example, only a touch-type key or a rotary-type key is disposed, or a push-type key and a touch-type key or a rotary-type key are disposed, or a touch-type key and a rotary-type key are disposed.

The dressing table 1 in the embodiment controls the light-emitting lamp 162 through two ways of voice and the control key 1614, facilitating users to choose different control ways in different scenarios, so as to meet requirements of different users in different scenarios.

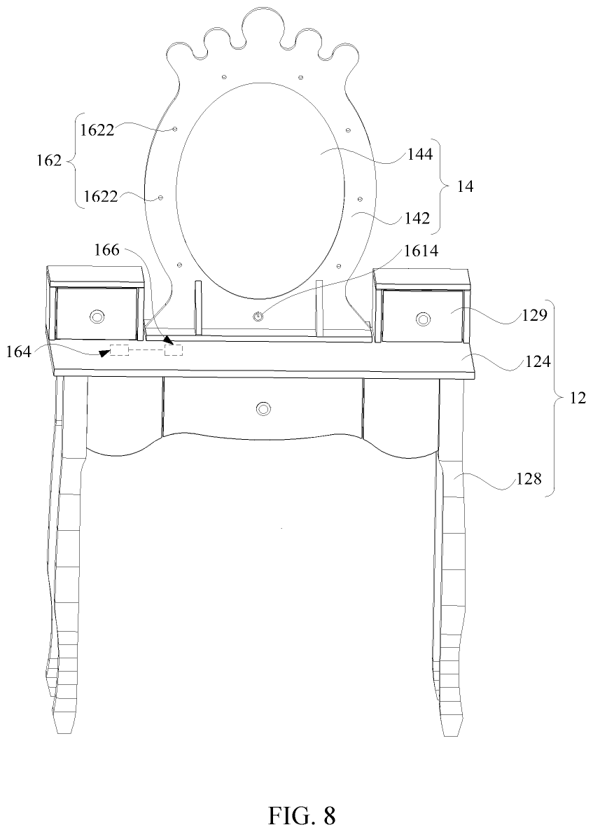

Referring to FIG. 8, FIG. 8 is a second structural schematic diagram of the dressing table shown in FIG. 1 at the other angle. In some optional embodiments, the voice collector 164 and the controller 166 are disposed on the mirror table 12. The dressing mirror 14 is only disposed with the light-emitting lamp 162, so that structure of the dressing mirror 14 is simplified. Space in the mirror table 12 is far larger than space in the dressing mirror 14, which is convenient to contain the voice collector 164 and the controller 166.

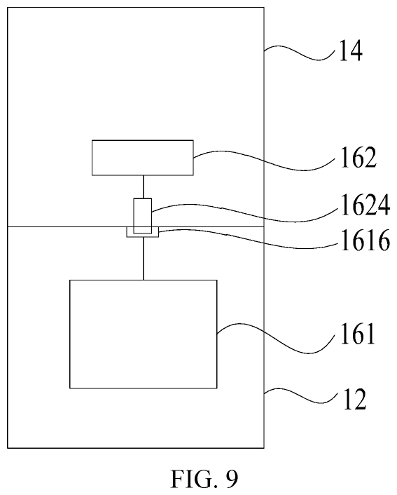

Referring to FIG. 9, FIG. 9 is a simplified schematic diagram of the dressing table shown in FIG. 8. In some embodiments, the dressing table 1 further includes a circuit board 161. The voice collector 164 and the controller 166 are disposed on the circuit board 161. The circuit board 161 is disposed on the mirror table 12. The circuit board 161 includes a third interface 1616. The light-emitting lamp 162 includes a fourth interface 1624. The third interface 1616 is electrically connected to the fourth interface 1624 for enabling the circuit board 161 to supply power to the light-emitting lamp 162.

The third interface 1616 of the circuit board 161 disposed on the mirror table 12 is electrically connected to the fourth interface 1624 of the light-emitting lamp 162, and the circuit board 161 supplies power to the light-emitting lamp 162 through the electrically connected third interface 1616 and the electrically connected fourth interface 1624. The third interface 1616 and the fourth interface 1624 are disposed according to requirements, such as a USB interface, a Micro-USB interface, or a Type-C interface, and so on. The third interface 1616 and the fourth interface 1624 are further other interfaces, and the embodiment does not limit the third interface 1616 and the fourth interface 1624.

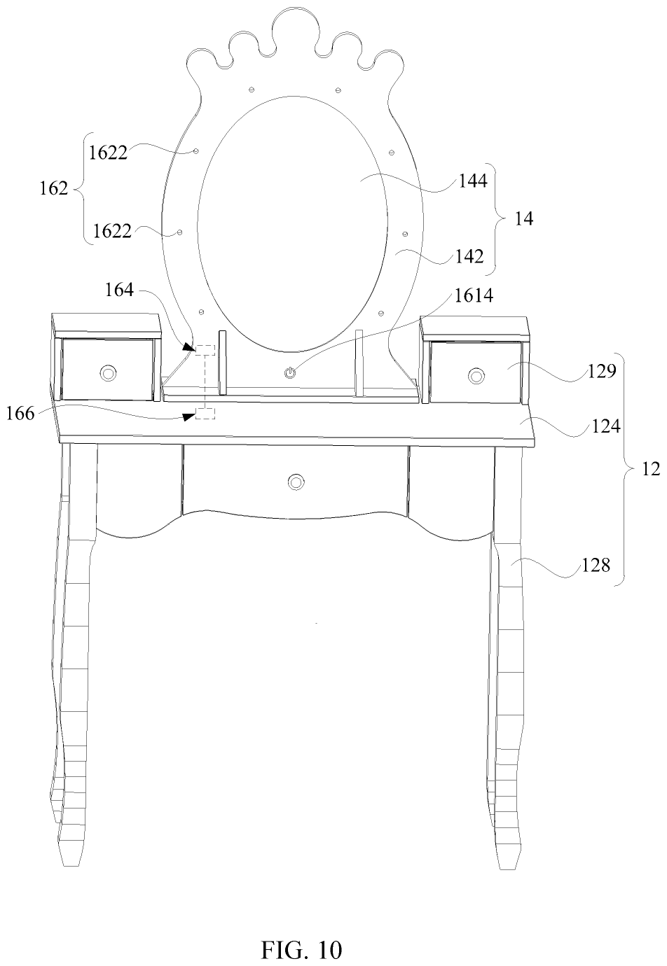

Referring to FIG. 10, FIG. 10 is a third structural schematic diagram of the dressing table shown in FIG. 1 at the other angle. In some optional embodiments, the voice collector 164 is disposed on the dressing mirror 14. The controller 166 is disposed on the mirror table 12. The voice collector 164 and the light-emitting lamp 162 are both electrically connected to the controller 166. The voice collector 164 is disposed on the dressing mirror 14 to conveniently collect the voice information of the user, and the controller 166 is disposed on the mirror table 12 to simplify the structure of the dressing mirror 14.

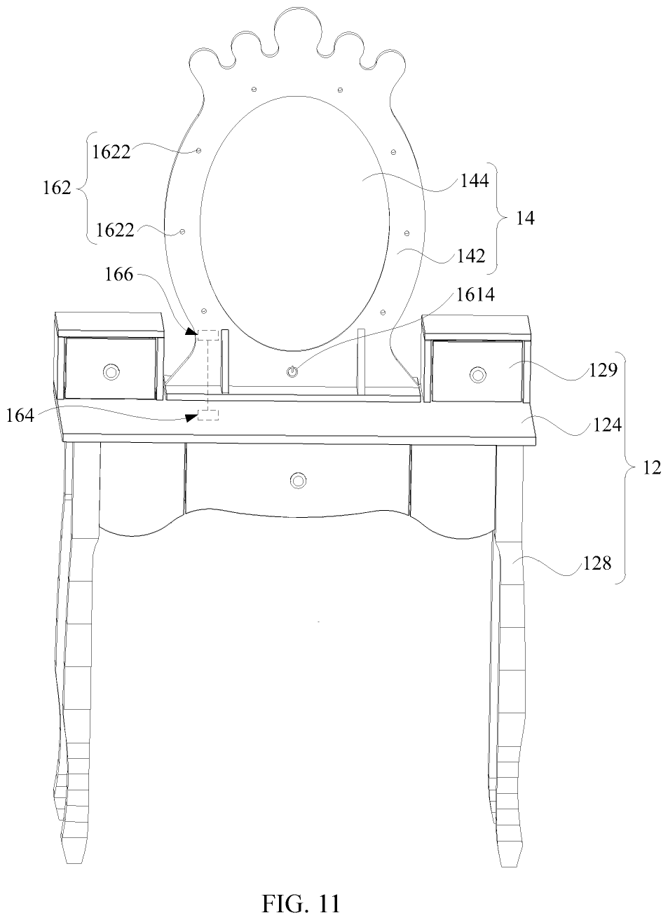

Referring to FIG. 11, FIG. 11 is a fourth structural schematic diagram of the dressing table shown in FIG. 1 at the other angle. In some optional embodiments, the controller 166 is disposed on the dressing mirror 14. The voice collector 164 is disposed on the mirror table 12. The voice collector 164 and the light-emitting lamp 162 are both electrically connected to the controller 166. The voice collector 164 is disposed on the mirror table 12, the dressing mirror 14 does not need to be defined with a sound hole configured to collect the voice information of the user, the sound hole defined in the mirror table 12 is not obvious, which makes small influence on the overall appearance. The controller 166 is disposed on the dressing mirror 14, which is more convenient for controlling the light-emitting lamp 162.

The controller 166 is disposed on a back surface of the dressing mirror 14 and does not occupy mirror surface area of the dressing mirror 14 as much as possible.

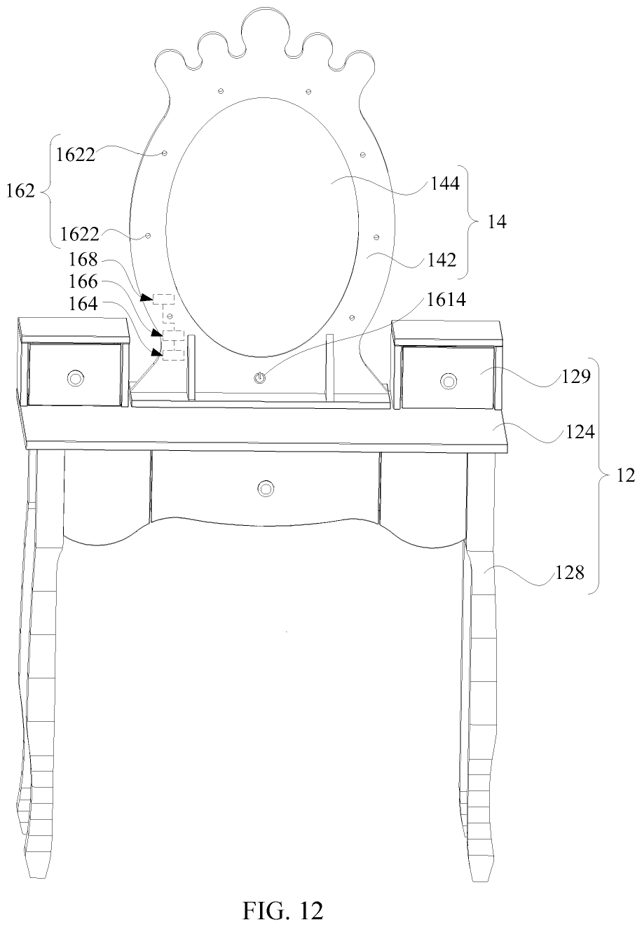

Referring to FIG. 12, FIG. 12 is a fifth structural schematic diagram of the dressing table shown in FIG. 1 at the other angle. In some optional embodiments, the dressing table 1 further includes a voice player 168. The voice player 168 is connected to the controller 166. The voice player 168 plays audio signals sent by the controller 166. The voice player 168 play corresponding audio information, such as music playing and the like. The voice player 168 is a speaker.

In some embodiments, the dressing table 1 further includes a wireless communication circuit, such as a Bluetooth wireless circuit. The Bluetooth wireless circuit is in wireless communication with a mobile phone of a user, and voice information of the mobile phone is played through the voice player 168, such as voice communication, music playing, and the like

In some embodiments, the controller 166 is in voice interaction with a user through the voice collector 164 and the voice player 168. That is, the controller 166, the voice collector 164, and the voice player 168 implement chats with the user. The controller 166 integrates a chat function module. Certainly, the dressing table 1 further includes a chat function module, and the controller 166 is electrically connected to the chat function module.

Certainly, the dressing table 1 further includes a communication circuit. The controller 166 communicates with an external device through the communication circuit. The controller 166 acquires information through the communication circuit, for example, obtaining weather information, answering to questions of the user, etc. The communication circuit is a wired communication circuit or a wireless communication circuit. The wireless communication circuit is a WIFI communication circuit, a 2G communication circuit, a 3G communication circuit, a 4G communication circuit, or a 5G communication circuit and the like.

The voice player 168 and the voice collector 164 are disposed at intervals on the dressing mirror 14. The voice player 168 and the voice collector 164 are further disposed at intervals on the mirror table 12. Or one of the voice player 168 and the voice collector 164 is disposed on the dressing mirror 14, and the other one of the voice player 168 and the voice collector 164 is disposed on the mirror table 12. For example, the voice collector 164 is disposed on the dressing mirror 14, and the voice player 168 is disposed on the mirror table 12. For another example, the voice collector 164 is disposed on the mirror table 12, and the voice player 168 is disposed on the dressing mirror 14. Therefore, mutual interference between the voice player 168 and the voice collector 164 is prevented.

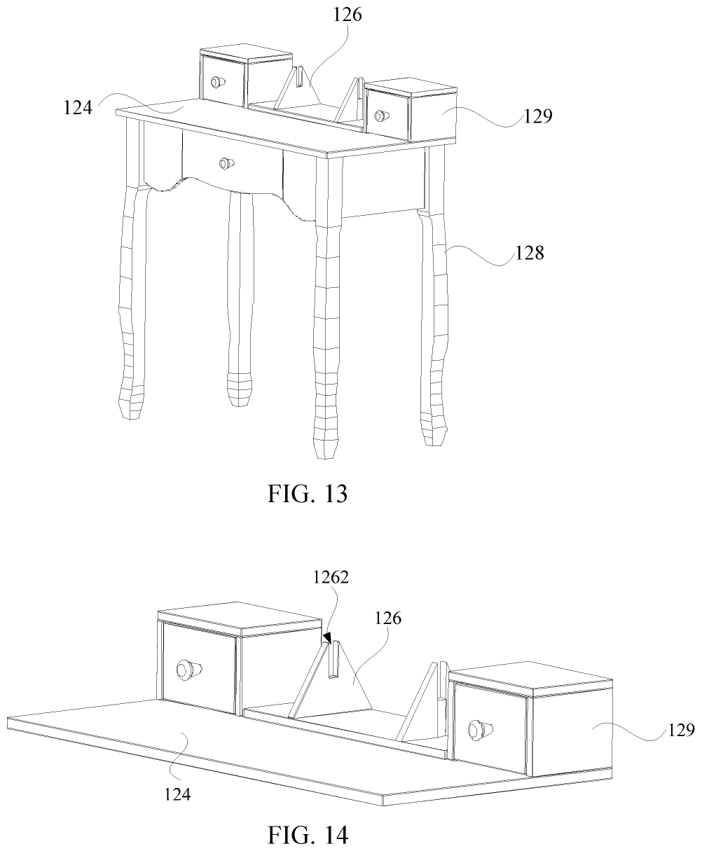

Referring to FIGS. 13-14, FIG. 13 is a structural schematic diagram of a mirror table in the dressing table shown in FIG. 1. FIG. 14 is a partial structural schematic diagram of the mirror table shown in FIG. 13. In some optional embodiments, the dressing table 12 includes a bearing plate 124, two mounting frames 126, and a plurality of supporting legs 128. The plurality of the supporting legs 128 and the two mounting frames 126 are disposed on two opposite sides of the bearing plate 124. The plurality of the supporting legs 128 are connected to the bearing plate 124 for supporting the bearing plate 124. The two mounting frames 126 are disposed at intervals. A mounting groove 1262 is defined on each of the two mounting frames 126. The dressing mirror 14 is clamped in the two mounting grooves 1262.

The mirror table 12 further includes two dressing boxes 129. The two dressing boxes 129 and the two mounting frames 126 are disposed on a same side of the bearing plate 124. The two dressing boxes 129 are disposed on two sides of the dressing mirror 14.

In some optional embodiments, the dressing table further includes a heater. The heater is disposed on a back surface of the dressing mirror. The heater heats the dressing mirror to remove mist on the surface of the dressing mirror. The heater is electrically connected to the controller, and the controller controls opening or closing of the heater. The controller controls the opening or the closing of the heater through voice, or automatically opens or closes the heater according to environment humidity, humidity of the mirror, and the like. Certainly, there are other ways to control the opening or the closing of the heater, such as setting keys to control the opening or the closing of the heater.

The above describes in detail the dressing table provided by the embodiments of the present disclosure. In the present disclosure, specific embodiments are configured to illustrate principles and implementation methods of the present disclosure. The description of the above embodiments is only configured to help to understand methods and core ideas of the present disclosure. Meanwhile, for those skilled in the art, based on the ideas of the present disclosure, there are changes in the specific implementation methods and application scope. In conclusion, content of the specification should not be understood as limitation to the present disclosure.

What is claimed is:

1. A dressing table, comprising:
a mirror table;
a dressing mirror;
a light-emitting lamp;
a voice collector; and
a controller;
wherein the dressing mirror is disposed on the mirror table; the light-emitting lamp is disposed on the dressing mirror; the voice collector collects voice information; the controller is electrically connected to the voice collector and the light-emitting lamp, and the controller controls the light-emitting lamp according to the voice information.

2. The dressing table according to claim 1, wherein the voice collector and the controller are disposed on the dressing mirror.

3. The dressing table according to claim 2, wherein the dressing mirror comprises a mounting bracket and a mirror, the mirror is disposed on the mounting bracket, the mounting bracket is disposed on the mirror table, and an accommodating space is formed in the mounting bracket; and
the dressing table further comprises a circuit board, the voice collector and the controller are disposed on the circuit board, and the circuit board is disposed in the accommodating space.

4. The dressing table according to claim 3, wherein an opening is formed in an edge of the mounting bracket, and the opening is communicated with the accommodating space;
the circuit board comprises a first interface, and the first interface is disposed in the opening; and
the mirror table comprises a second interface for supplying power, and the second interface is plugged into the first interface to achieve electrical connection and supply power to the circuit board.

5. The dressing table according to claim 3, wherein the circuit board further comprises a wireless receiving circuit; and
the mirror table comprises a wireless transmitting circuit, and the wireless transmitting circuit is matched with the wireless receiving circuit for supplying power to the circuit board.

6. The dressing table according to claim 3, wherein the dressing table further comprises a battery, the battery is disposed in the accommodating space, and the battery is electrically connected to the circuit board for supplying power to the circuit board.

7. The dressing table according to claim 3, wherein the light-emitting lamp comprises a plurality of light-emitting units, and the plurality of the light-emitting units are disposed around the mirror by a circle.

8. The dressing table according to claim 1, wherein the dressing table further comprises a control key, the control key is disposed on the dressing mirror, and the control key is electrically connected to the light-emitting lamp for controlling the light-emitting lamp.

9. The dressing table according to claim 1, wherein the voice collector and the controller are disposed on the mirror table.

10. The dressing table according to claim 9, wherein the dressing table further comprises a circuit board, the voice collector and the controller are disposed on the circuit board, the circuit board is disposed on the mirror table, the circuit board comprises a third interface, the light-emitting lamp comprises a fourth interface, and the third interface is electrically connected to the fourth interface for enabling the circuit board to supply power to the light-emitting lamp.

11. The dressing table according to claim 1, wherein the voice collector is disposed on the dressing mirror, the controller is disposed on the mirror table, and the voice collector and the light-emitting lamp are both electrically connected to the controller.

12. The dressing table according to claim 1, wherein the controller is disposed on the dressing mirror, the voice collector is disposed on the mirror table, and the voice collector and the light-emitting lamp are both electrically connected to the controller.

13. The dressing table according to claim 12, wherein the controller is disposed on a back surface of the dressing mirror.

14. The dressing table according to claim 1, wherein the dressing table further comprises a voice player, the voice player is connected to the controller, and the voice player plays audio signals sent by the controller.

15. The dressing table according to claim 14, wherein the controller is in voice interaction with a user through the voice collector and the voice player.

16. The dressing table according to claim 15, wherein the voice player and the voice collector are disposed at intervals on the dressing mirror.

17. The dressing table according to claim 15, wherein the voice player and the voice collector are disposed at intervals on the mirror table.

18. The dressing table according to claim 15, wherein the voice player is disposed on the dressing mirror, and the voice collector is disposed on the mirror table; or
the voice collector is disposed on the dressing mirror, and the voice player is disposed on the mirror table.

19. The dressing table according to claim 1, wherein the dressing table comprises a bearing plate, two mounting frames, and a plurality of supporting legs; the plurality of the supporting legs and the two mounting frames are disposed on two opposite sides of the bearing plate, the plurality of the supporting legs are connected to the bearing plate for supporting the bearing plate, the two mounting frames are disposed at intervals, a mounting groove is defined on each of the two mounting frames, and the dressing mirror is clamped in the two mounting grooves.

20. The dressing table according to claim 19, wherein the mirror table further comprises two dressing boxes, the two dressing boxes and the two mounting frames are disposed on a same side of the bearing plate, and the two dressing boxes are disposed on two sides of the dressing mirror.
